(19) United States
(12) Patent Application Publication
(10) Pub. No.: US 2007/0131015 A1
(43) Pub. Date: Jun. 14, 2007

(54) Pipe Member, Method of Manufacturing the Same, and Roller Using the Same

(75) Inventors: Takashi MATSUMURA, Suwa-shi, Nagano-ken (JP); Hiroshi HASHIZUME, Suwa-shi, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/610,361

(22) Filed: Dec. 13, 2006

(30) Foreign Application Priority Data
Dec. 14, 2005 (JP) 2005-359910

(51) Int. Cl. B21D 53/00; F16C 13/00; B21C 37/06

(52) U.S. Cl. 72/368; 138/151; 138/171; 29/895; 492/53

(57) ABSTRACT

In order to manufacture a pipe member there is provided a metal sheet having a first end and a second end extending in a first direction corresponding to an axial direction of the pipe member. First convex portions and first concave portions are alternately formed on the first end of the metal sheet. Second convex portions and second concave portions are alternately formed on the second end of the metal sheet. Each of the first end and the second end of the metal sheet Is curved so as to have an arcuate cross section as viewed in the first direction. A center part of the metal sheet relative to a second direction corresponding to a circumferential direction of the pipe member is curved so as to have an arcuate cross section as viewed in the first direction. The first convex portions and the second convex portions are press-fitted respectively into the second concave portions and the first concave portions in a third direction corresponding to a radial direction of the pipe member.

### BACKGROUND_

1. Technical Field

The present invention relate to a pipe member, a method of manufacturing the same, and a roller using the same. In particular, the invention relates to a pipe member that is manufactured by curving a metal sheet, a method of manufacturing the same, and a roller using the same.

2. Background Art

There are many technologies that manufacture pipe members by curving a metal sheet. Among these, a technology is disclosed in Japanese Patent Publication No. 2003-245721A (JP-A-2003-245721) that manufactures a pipe member having a small diameter by curving a relatively thin metal sheet. That is, JP-A-2003-245721 teaches that a pipe member is formed such that a metal sheet conveyed by a guide belt is brought into close contact with a core roller by a pair of pressing rollers. The core roller has the substantially same diameter as an inner diameter of a pipe member to be manufactured. The pair of pressing rolls is follower rollers of the core roller. According to this configuration, a pipe member can be formed with no barrel-shaped deformation.

In order to reduce costs, a pipe member is needed instead of a non-hollowed metal rod manufactured by a cutting work. However, there has not been suggested how to manufacture a pipe member having sufficient surface roundness and axial linearity.

### SUMMARY

It is therefore one advantageous aspect of the invention to provide a pipe member having surface roundness and axial linearity, a method of manufacturing the same, and a roller using the same.

According to one aspect or the invention, there is provided a pipe member formed from a metal sheet, comprising:
a joint section at which a first end and a second end of the metal sheet extending in an axial direction of the pipe member are joined, the joint section including:
   first convex portions and first concave portions alternately arranged on the first end of the metal sheet and
   second convex portions and second concave portions alternately arranged on the second and of the metal sheet, wherein:
each of the first convex portions and the second convex portions has a larger width as being farther from the first end and the second end of the metal sheet, respectively;
each of the first concave portions has a shape complementary to an associated one of the second convex portions, so that the second convex portions are fitted into the first concave portions; and
each of the second concave portions has a shape complementary to an associated one of the first convex portions, so that the first convex portions are fitted into the second concave portions,

Each of the first convex portions and the second convex portions may be formed with a protrusion protruded in the axial direction of the pipe member.

According to one aspect or the invention, there is provided a roller, comprising: the above pipe member; and an elastic layer, formed on an outer periphery of the pipe member.

According to one aspect of the invention, there is provided a method of manufacturing a pipe member, comprising:
providing a metal sheet having a first end and a second end extending in a first direction corresponding to an axial direction of the pipe member;
forming first convex portions and first concave portions alternately on the first end of the metal sheet;
forming second convex portions and second concave portions alternately on the second end of the metal sheet:
curving each of the first end and the second end of the metal sheet so as to have an arcuate cross section as viewed in the first direction;
curving a center part of the metal sheet relative to a second direction corresponding to a circumferential direction of the pipe member, so as to have an arcuate cross section as viewed in the first direction; and
press-fitting the first convex portions and the second convex portions respectively into the second concave portions and the first concave portions in a third direction corresponding to a radial direction of the pipe member.

Each of the first convex portions and the second convex portions may be so formed as to have a larger width as being farther from the first end and the second end of the metal sheet, respectively.

Each of the first convex portions and the second convex portions may be formed with a protrusion protruded in the first direction.

The metal sheet may be provided by rolling a metal block in hie second direction.

According to one aspect of the invention, there is provided a method of manufacturing a roller, comprising:
placing the pipe member manufactured by the above method in a die; and
injecting a molten elastic materiel into the die to form an elastic layer on an outer periphery of the pipe member.

### BRIEF DESCRIPTION OF THE DRAWING

FIG. 1 is a partial perspective view of a pipe member according to one embodiment of the invention.

FIG. 2A is a plan view of a metal sheet for forming the pipe member.

FIG. 2B is an enlarged plan view showing convex portions and concave portions formed on joint ends of the metal sheet,

FIGS. 3A through 7B are side views showing how to perform works for curving the metal sheet.

FIGS. 8A to 8C are perspective views showing how to perform the works for curving the metal sheet

FIG. 9A is a partial perspective view of a fusing roller incorporating the pipe member.

FIG. 9B is a side view of the fusing roller.

FIG. 10 is a schematic section view showing how to manufacture the fusing roller.

FIG. 11 is a partial perspective view for explaining an advantage of the fusing roller.

### DETAILED DESCRIPTION OF EXEMPLARY EMODIMENTS

Exemplary embodiments or the invention will be described below In detail with reference to the accompanying drawings.

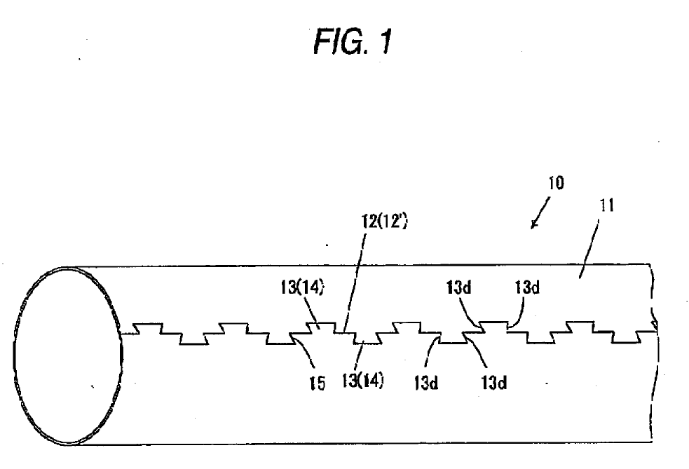

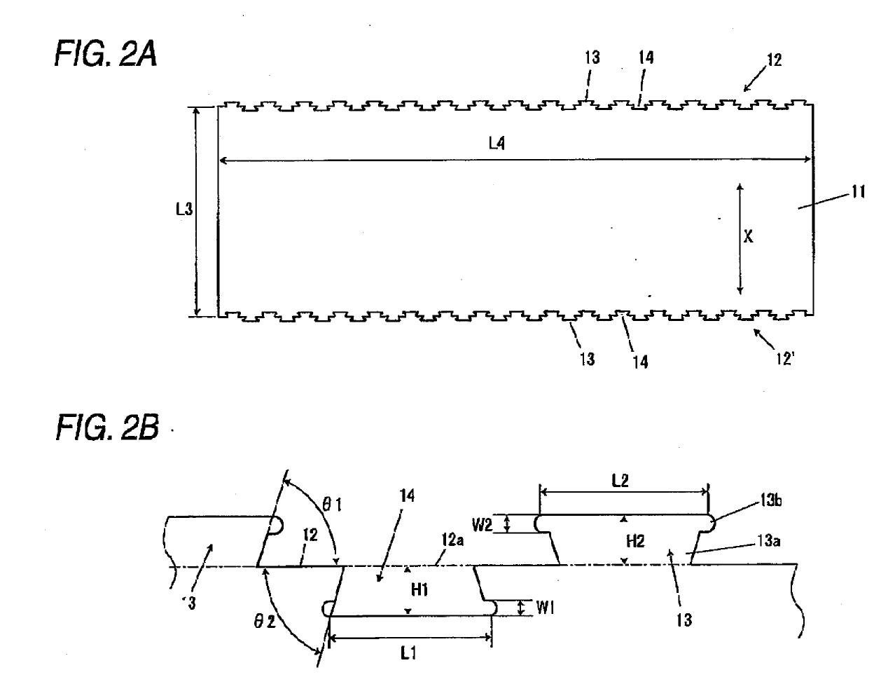

As shown in FIG. 1 through 2B, a pipe member 10 is formed by curving a metal sheet 11 in a cylindrical shape. At a pair of joint ends 12 and 12′ (sometimes collectively represented by reference numeral 12) of the metal sheet 11, convex portions 13 that include portions having a larger width as being farther from the end 12, and concave portions 14 that have shapes complementary to the convex portions 13 and are fitted into the convex portions 13 are alternately arranged in an axial direction of the pipe member 10. Further, in the pipe member if), press fitting portions 15 described below are provided between the convex portions 13 and the concave portions 14. Then, the convex portions 13 and the concave portions 14 arc press-fitted in the radial direction of the pipe member 10. The convex portions 13 and the concave portions 14 are arranged at the same pitches in the axial direction of the pipe member 10.

As shown in FIG. 2B, each of the convex portions 13 has a tapered portion 13a that has a larger width as being farther from the end 12, and protruded portions 13b that are protruded from both sides of a tip end of the tapered portion 13a in the axial direction of the pipe member 10.

In this embodiment, when a reference line tar forming the convex portions 13 and the concave portions 14 at the end 12 is denoted by reference numeral 12a, the press fitting portions 15 are formed to satisfy the following conditions.
θ1<02
W1<W2
L1<L2
   Here, θ1 is an angle between the reference line 12a and a side edge of the tapered portion 13a in the convex portion 13, and θ2 is an angle between an inner side edge in the concave portion 14 corresponding to the side edge of the tapered portion 13a and the reference line 12a. Further, W2 is a width of the protruded portion 13b in the convex portion 13, rind W1 is a width of a protruded portion in the concave portion 14. In addition, L2 is the largest length not including arcs of the protruded portions 13b of the convex portion 13. and L1 is a length in the concave portion 14 corresponding to the convex portion 13.

For examples, when a thickness of the metal sheet 11 is 0.4 mm, a length L3 (see Fig ZA) between the ends 12 and 12′ (between the reference lines 12a) is 101.484 mm, and an axis length is 336 mm, the press fitting portions 15 are formed to satisfy the following conditions.
θ1(=70 degrees)<θ2(=71 degrees)
W1(=0.95 mm)<W2(=1 mm)
L1(8.1 mm)<L2(=8.2 mm)
   In this embodiment, a case where a height H2 of the convex portion 13 is consistent with a depth H1 of the concave portion 14 has been described. Alternatively, the press fitting portion 15 may be formed to satisfy the condition H1<H2 (for example, with a difference of approximately 0.05 mm), in addition to the above-described dimensional relationship.

The pipe member 10 shown in FIG. 1 is formed by, first, curving the ends 12 of the metal sheet 11 shown in FIG. 2A in a circular arc shape as viewed in the axial direction of the pipe member, then curving a central portion of the metal sheet 11 in a circular arc shape as viewed in the axial direction of the pipe member, and subsequently press-fitting the convex portions 13 and concave portions 14 at the ends 12 in the radial direction of the pipe member.

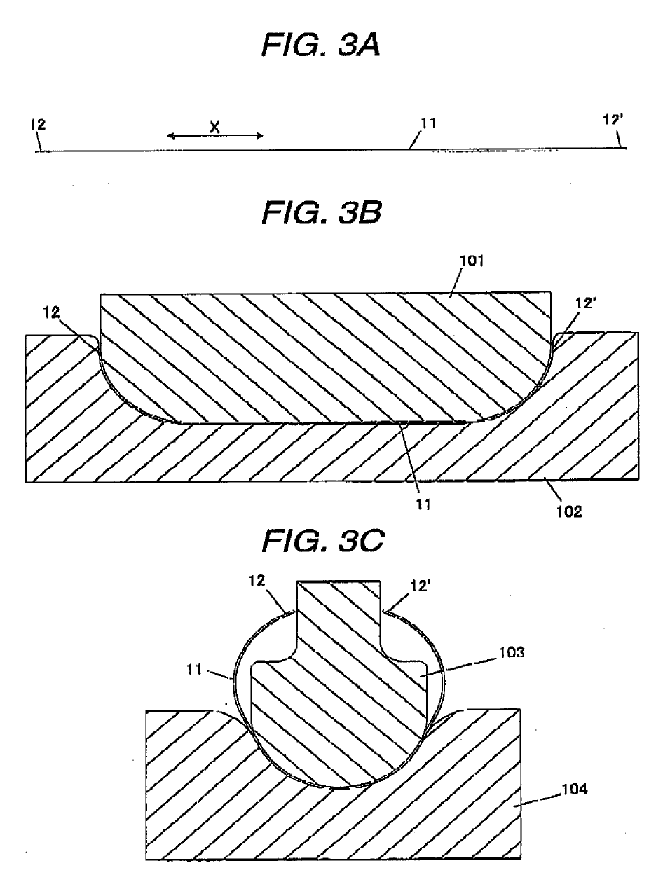

The curving work of the metal sheet 11 will be sequentially described below with reference to FIGS. 3A through 7B.

As shown in FIG. 3A, the metal sheet 11 formed with the convex portions 13 and the concave portions 14 is first provided. In FIGS. 2A and 3A, a direction of an arrow X indicates a rolling direction when the metal sheet 11 is manufactured by a rolling work.

As shown in FIG. 3B. the metal sheet 11 is then pressed by male and female dies 101 and 102, and then the ends 12 and 12′ are curved in a circular arc shape. Preferably, a quarter of the width from each of the ends 12 and 12′ of the metal sheet 11 is curved in a quarter circular arc shape.

As shown in FIG. 30, the central portion of the metal sheet obtained by the work of FIG. 3B is then curved so as to have an arcuate cross section as viewed in the axial direction of the pipe member 10 (preferably, an arc having a center angle of 130 degrees) by pressing with the male and female dies 103 and 104. The male die 103 has a narrow width so as to let the ends 12 and 12′ of the metal sheet 12 be free.

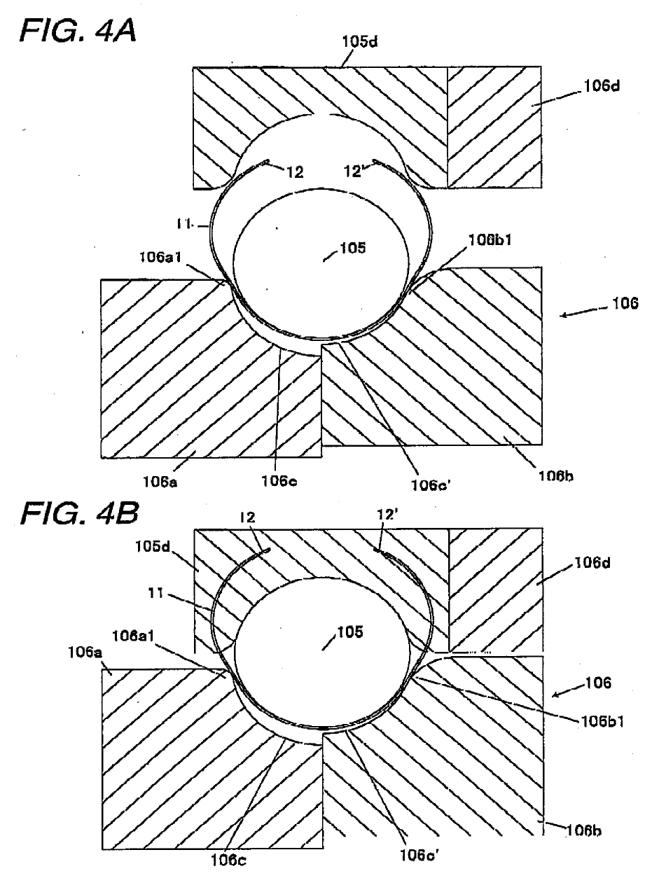

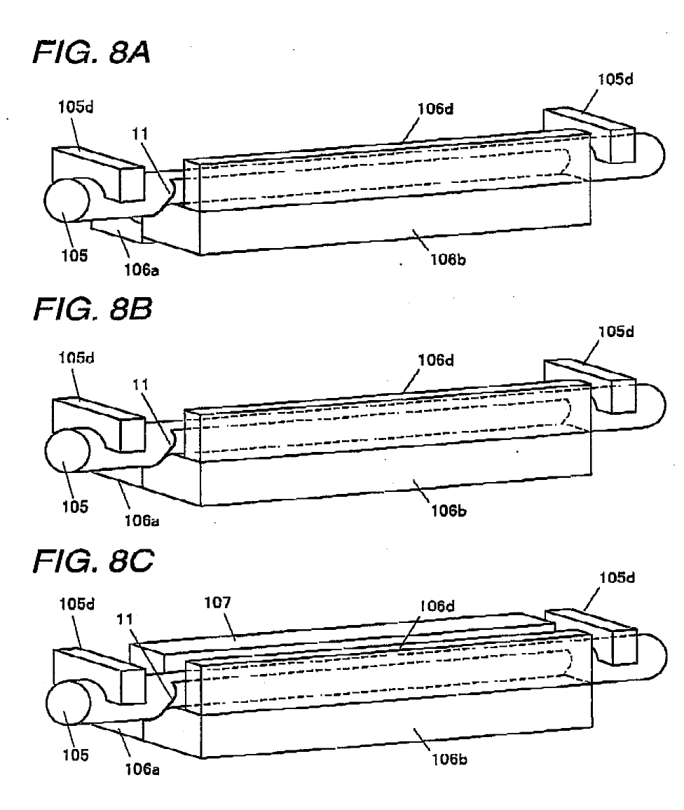

Next, as shown in FIG. 4A, a core die 105 is disposed inside the metal sheet 11 obtained by the work of FIG. 30. Then as shown in FIGS. 4B through 7, the metal sheet 11 is formed so as to have a e-shaped cross section as viewed in the axial direction of the pipe member 10, and then the ends 12 and 12′ are press-fitted to each other to form the cylindrical pipe member 10. The details will be described below with reference to FIGS. 8A to 8C.

An outer diameter of the core die 105 is smaller than an inner diameter of the pipe member 10 to be manufactured. This is because the spring back of the metal sheet 11 occurred during the working is taken into account.

The lower die 106 shown in FIGS. 4A to 8H is a die that is divided into left and light parts. A right die 106b can move up and down and is urged upward by a not-shown urging member (for example, a spring).

The radius of each of the pressing surfaces 106c and 106c′ of the left die 106a and right die 106b is smaller than an inner diameter (radius) of the pipe member 10 to be manufactured. This is because the spring back of the metal sheet 11 is taken into account, as described below.

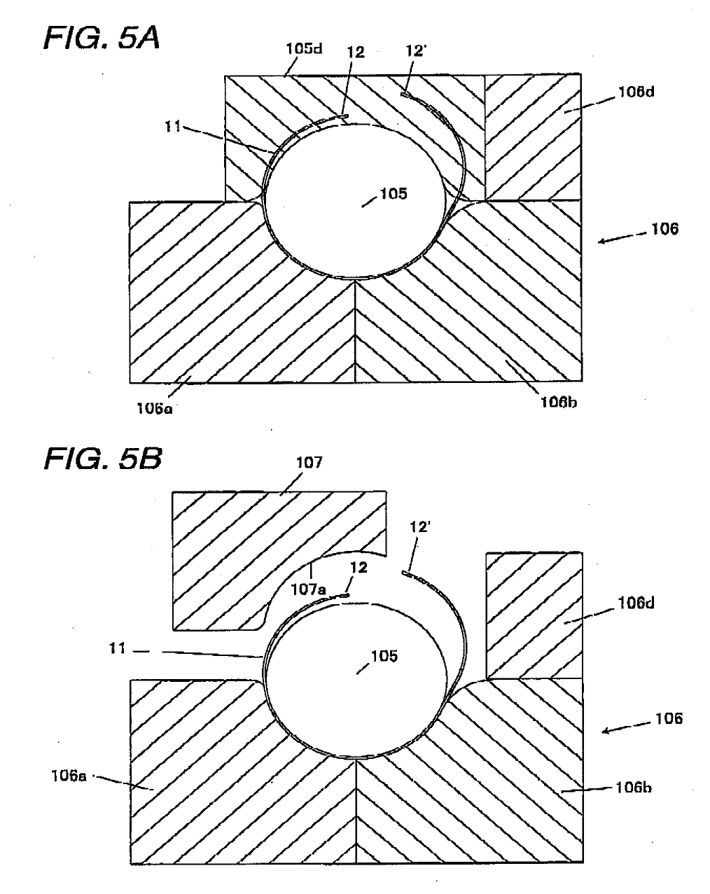

Reference numeral 105d denotes pressing-down members for the core die 105 that are provided on both ends of the core die 105. Reference numeral 116d denotes a pressing-down member of the right die 106b that is provided on the right die 106b so as not to interfere with the metal sheet 11 doss not occur (see FIGS. 5A and 5B). The pressing-down member 106d moves down together with the pressing-down members 105d. In this specification, moving directions of the dies arm expressed as relative moving directions.

As shown in FIG. 4A, the metal sheet 11 obtained by the work of FIG. 3C is set on the lower die 106, and the core die 105 is inserted into the metal sheet 11.

As shown in FIGS. 4B and 8A, the pressing-down members 105d and 106d then move down such that the core die 105 presses the metal sheet 11 toward the lower die 108.

Subsequently, as shown in FIGS. 5A and 8B, while the pressing-down member 105d and 106d move down such that the core die 105 presses the motel sheet 11 toward the lower die 106, the pressing-down member 106d moves down the right die 106b at the same position as the left die 106a, Moreover, in a press apparatus shown in the drawings, a stopper (not shown) is provided to determine a stop position of the downward movement of the left die 106a.

Accordingly, a substantially lower half of the metal sheet 11 is formed into a half circle, and the entire metal sheet 11 is formed so as to have a 6-shaped cross section as viewed in the axial direction of the pipe member 10.

As shown in FIGS. 4B and 5A, while the core die 105 moves down and the metal shoot 11 is pressed down toward the lower die 106, the metal sheet 11 is guided so as to come into contact with inner edges 106a1 and 106b1 of the upper end of the left and right lower dies 106a and 108b. Here, a radius of curvature of the inner edge 106a1 of the upper end of one lower die (the left die 106a in the drawings) is small and a radius of curvature of the inner edge 106b1 of the upper and of the other lower die (the right die 106b in the drawings) is large. Specifically, the pressing surface 106c of the left die 106a has an arcuate cross section with a center angle of 90 degrees as viewed in the axial direction of the pipe member 10 but the pressing surface 106c′ of the right die 106b an arcuate cross section with a center angle of less than 90 degrees as viewed in the axial direction of the pipe member 10. With this arrangement, during the above working, a right half of the metal sheet 11 (in this figure) is not worked substantially. As a result, the lower half of the metal sheet 11 is formed in a semi-cylindrical shape and the entire metal sheet 11 is worked so as to have a 6-shaped cross section as viewed in the axial direction of the pipe member 10.

In FIG. 5B, reference numeral 107 denotes an upper die. Although the upper die 107 involves in the workings of FIGS. 4A through 5A, but it is not shown in the drawings for simplification.

The upper die 107 has a pressing surface 107a having an arcuate cross section with a center angle of more than 90 degrees as viewed in the axial direction of the pipe member 10. However, the pressing surface 107a does not interfere with the end 12′ on an opened side of the metal sheet 11. A radius of the pressing surface 107a is the same as the pressing surface 106c of the lower die 106, but smaller than the outer diameter (radius) of the pipe member 10 to be manufactured.

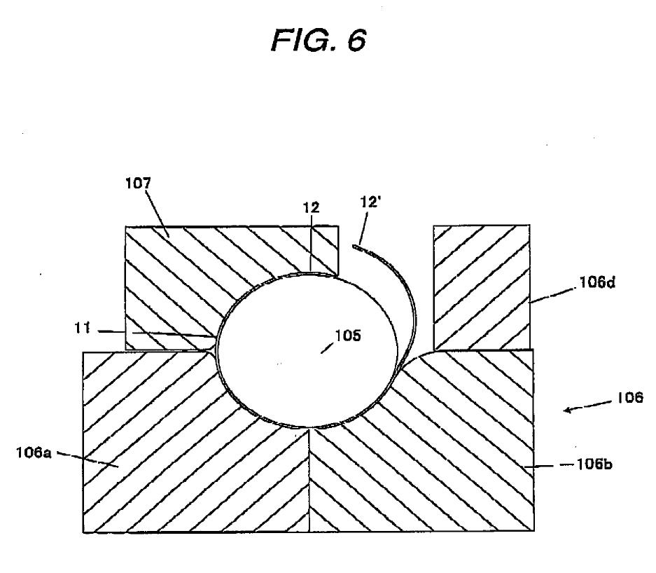

As shown in FIGS. 6 and 8C, the upper die 107 moves down, and then the left half of the metal sheet 11 (in this figure) is shaped into a semi-cylindrical.

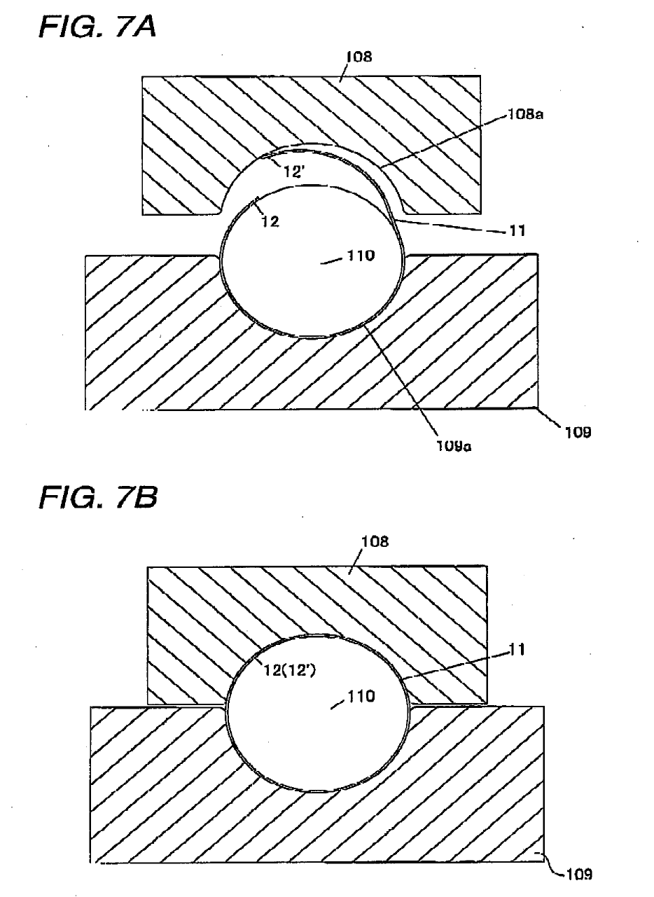

As shown in FIG. 7A, the metal sheet 11 obtained by the work of FIG. 6 is set between a final upper die 108 and a final lower die 109, and then a final core die 110 is inserted into the metal shoot 11. The metal sheet 11 is set in a state that the non-worked end 12′ faces a pressing surface 108a of the final upper die 108. That is, the metal sheet 11 is set in a state that it is rotated counterclockwise from the state shown in FIG. 6.

The radius of the pressing surface 108a of the final upper die 108 and the radius of a pressing surface 109a of the final lower die 109 are the same as the outer diameter of the pipe member 10 to be manufacture. The outer diameter of the final core die 110 is the same as the inner diameter of the pipe member 10 to be manufactured.

As shown in FIG. 7B, the final upper die 108 is moved down to move the ends 12 and 12′ of the metal sheet 11 inward to be press-fitted to each other, so that the upper half of the metal sheet 11 (in this figure) is shaped into semi-cylindrical. As a result, the metal sheet 11 is shaped into complete cylindrical, and the pipe member 10 shown in FIG. 1 is obtained.

In the works shown in FIGS. 4A through 6, it the radiuses of the pressing surfaces of the dies 105, 106 and 107 were the same as the outer diameter of the pipe member 10 to be manufactured, like the radiuses of the final dies 108, 109 and 110, due to the spring back of the metal sheet 11, there is a probability that the convex portions 13 and concave portions 14 of the ends 12 and 12′ are misaligned when the metal sheet 11 is set in the final dies 108 and 109 and the final core die 110, so that the press-fitting cannot be duly performed.

According to this embodiment, however, even though the spring back occurs in the metal sheet 11 after the work of FIG. 6, the ends 12 and 12′ can be properly press-fitted into each other. In other words, the radiuses of the pressing surfaces of the dies 106, 107 and the outer diameter of the core die 105 shown in FIGS. 4A through 6 are determined in consideration of the spring back of the metal shoot 11 occurred after the work of FIG. 5.

The pipe member 10 of the above embodiment is formed by curving the metal sheet 11 in a cylindrical shape. Specifically, there are alternately provided the convex portions 13 that include portions having a larger width as being farther from the joint ends 12, 12′ of the metal sheet 11 and the concave portions 14 that have the shapes complementary to the convex portions 13 and that are fitted into the convex portions 13. Further, the press fitting portions 15 are provided between the convex portions 13 and the concave portions 14, and the convex portions 13 and concave portions 14 are press-fitted to each other in the radial direction of the pipe member 10. Accordingly, the ends 12 and 12′ are reliably prevented from being separated and opened by the spring back of the metal sheet 10. Therefore, it is possible to provide a pipe member having excellent surface roundness and axial linearity, without using a specific joining work, such as welding.

That is, in the pipe member 10, even though an extension force acts on the pipe member 10 along the circumference thereof due to the spring back of the metal sheet 11, press-fitting between the convex portions 13 and the concave portions 14 are not released. As a result, the pipe member 10 can be used as a cylindrical shaft as it is, without needing a work such as welding or adhesion.

Each of the convex portions 13 has a tapered portion 13a that has a larger width as being farther from the joint ends 12, 12′ and protruded portions 13b that are protruded in the axial direction of the pipe member 10 at both ends of the tip end of the tapered portion 13a. Accordingly, the separation of the ends 12 and 12′ due to the spring back of the metal sheet 11 can be further reliably avoided.

In general, a pipe member can be formed by performing an extrusion 5 molding and a drawing work to provide a metal sheet, and joining both ends extending straight in the axial direction of the pipe member. However, welding is required and thus it is difficult to maintain high accuracy in the outer diameter (roundness and linearity). In order to improve accuracy in the diameter, abrasive machining is additionally required. Further, a metal sheet having convex portions and concave portions as described the above cannot be shaped in a cylindrical shape by the known extrusion molding and the known drawing work.

On the other hand, according to this embodiment, a cylindrical pipe member 10 can be easily manufactured by curving both ends 12 and 12′ of the metal sheet 11 so as to have an arcuate cross section as viewed in the axial direction of the pipe member 10, then curving the central portion of the metal sheet 11 so as to have an arcuate cross section as viewed in the axial direction of the pipe member 10, and finally press-fitting the convex portions 13 and the concave portions 14 of the ends 12 and 12′ in the radial direction of the pipe member 10.

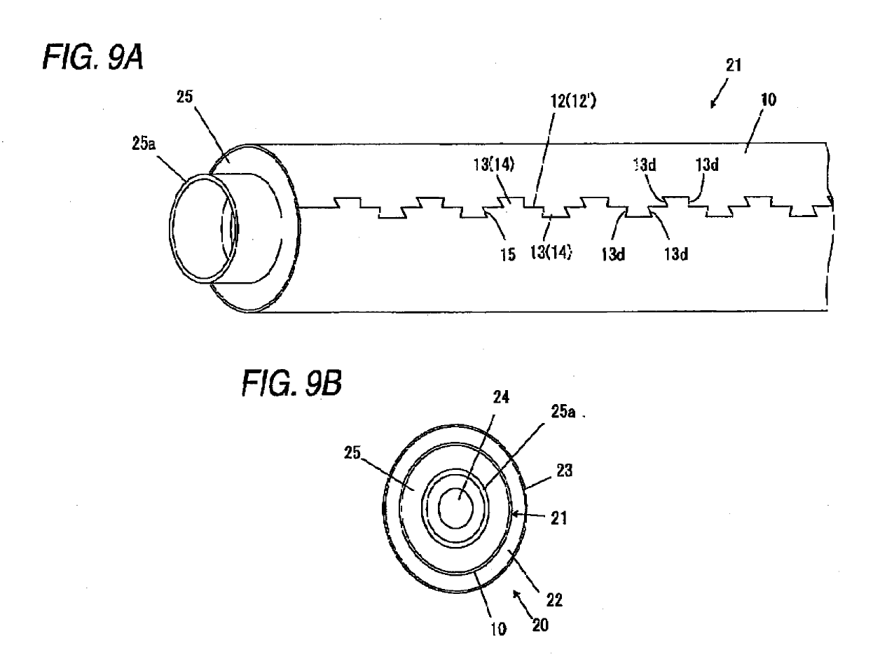

FIG. 9A shows a fusing roller 20 adapted to be incorporated in an image forming apparatus and serves to fuse a toner image on a recording medium such as paper. The fusing roller 20 has a shaft member 21 and an elastic layer 22 termed around the shaft member 21. An outer layer 23 having superior toner-separating property is formed around the surface of the elastic layer 22. A heat source (for example, a halogen lamp) 24 is disposed within a member 21.

As shown in FIG. 9B, a flange 25 having a hollow shaft part 25a is fitted into each of both axial ends (in the drawing, only one end is shown) of the above pipe member 10. The elastic layer 22 is formed around the pipe member 10 by injection molding as described below.

The hollow shaft part 25a of the fusing roller 20 is rotatably supported on a frame of a fusing device in the image forming apparatus through a bearing mechanism.

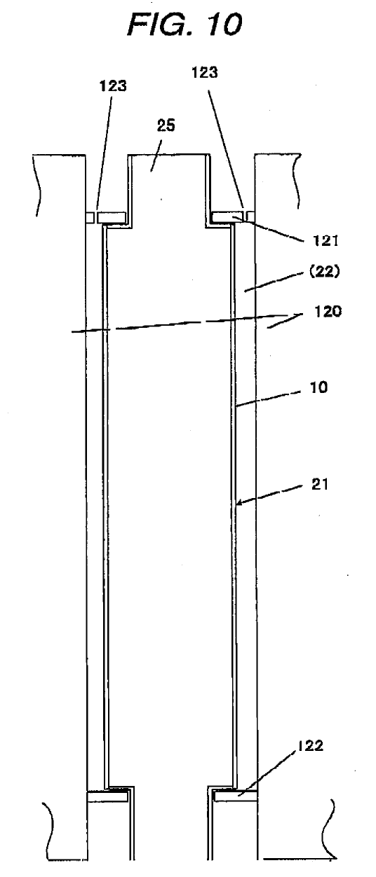

The elastic layer 22 is formed using a die 120 as shown in FIG. 10. In this figure, reference numerals 121, 122, and 123 respectively denote upper and lower end Gaps and a gate of a molten elastic material (for example, molten rubber) provided in the upper end cap 121. The fusing roller 20 is manufactured by setting the shaft member 21 in the dies and then injecting the molten elastic material through the gate 123.

In the fusing roller 20 having the above configuration, the elastic layer 22 is formed around the pipe member 10 by the injection molding. Further, in the pipe member 10, the convex portions 13 and the concave portions 14 of the metal sheet 11 are press-fitted in the radial direction 10 or the pipe member 10 by the press fitting portions 15 therebetween, such that separation of the ends 12 and 12′ due to the spring back of the metal sheet 11 are reliably prevented. As a result, a fusing roller having good accuracy in the outer diameter can be achieved.

Further, since the convex portions 13 and the concave portions 14 of the metal sheet are press-fitted in the radial direction of the pipe member 10, a gap does not exist between the convex portions 13 and the concave portions 14. Therefore, the elastic material does not leak to the inside of the pipe member 10 when the elastic layer 22 is formed around the pipe member 10. As a result, it is possible to manufacture the elastic layer 22 with good accuracy in the outer diameter.

As shown in FIG. 1, since the convex portions 13 and the concave portions 14 are alternately provided at the ends 12 and 12′ of the metal sheet 11 in the radial direction of the pipe member 10, a torsional force acting on the pipe member 10 can be absorbed by contact of opposing portions in the convexo-concave shapes in the axial direction of the pipe member 10 (contact portions indicated by reference numeral 13d in FIG. 1). Further, the torsional force arts in the engagement direction of the convex portion 13 and the concave portion 14 by the reaction of the tapered portion 13a (a direction in which press-fitting is not released). Accordingly, even though the ends 12 and 12′ are not joined by welding or the like, it is possible to provide a pipe member that is strong against a torsional force.

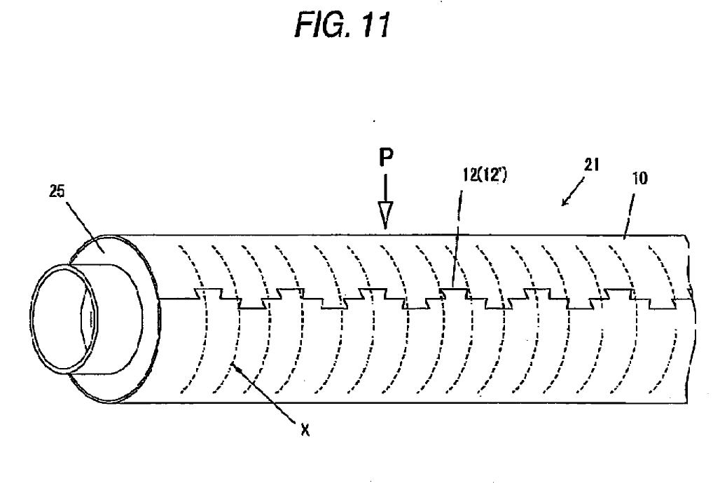

Since the pipe member 10 is curved such that the rolling direction (X direction in FIG. 2) for the metal sheet 11 for manufacturing the pipe member 10 is perpendicular to the axial direction of the pipe member 10, a direction of a crystal structure (crystal fiber) formed in the metal sheet 11 (represented by dashed lined in FIG. 11) by the rolling work is perpendicular to the axial direction of the pipe member 10. Therefore, a pipe member that is strong against a compression force P acting in a direction perpendicular to the axial direction of the pipe member 10 (see FIG. 11) can be obtained. As a result, a pipe member 10 that is suitable for a fusing roller can be obtained.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2005459910 filed Dec. 14, 2005 including specification, drawings and claims is incorporated herein by reference in its entirety.

What is claimed is:

1. A pipe member formed from a metal sheet, comprising:
a joint section at which a first end and a second end of the metal sheet extending in an axial direction of the pipe member are joined, the joint section including:
first convex portions arid first concave portions alternately arranged on the first end of the metal sheet; and
second convex portions and second concave portions alternately arranged on the second end of the metal sheet, wherein:
each of the first convex portions and the second convex portions has a larger width as being farther from the first end and the second end of the metal sheet, respectively;
each of the first concave portions has a shape complementary to an associated one of the second convex portions, so that the second convex portions are fitted into the first concave portions; and
each of the second concave portions has a shape complementary to an associated one of the first convex portions, so that the first convex portions are fitted into the second concave portions.

2. The pipe member as set forth in claim 1, wherein:
each of the first convex portions and the second convex portions is formed with a protrusion protruded in the axial direction of the pipe member.

3. A roller, comprising:
the pipe member as set forth in claim 1; and
an elastic layer, formed on an outer periphery of the pipe member.

4. A method of manufacturing a pipe member, comprising:
providing a metal sheet having a first end and a second end extending in a first direction corresponding to an axial direction of the pipe member;
forming first convex portions and first concave portions alternately on the first and of the metal sheet;
forming second convex portions and second concave portions alternately on the second end of the metal sheet;
curving each of the first end and the second end of the metal shoot so as to have an arcuate cross section as viewed in the first direction;
curving a center part of the metal sheet relative to a second direction corresponding to a circumferential direction of the pipe member, so as to have an arcuate cross section as viewed in the first direction; and
press-fitting the first convex portions and the second convex portions respectively into the second concave portions and the first concave portions in if a third direction corresponding to a radial direction of the pipe member.

5. The method as set forth in claim 4. wherein:
each of the first convex portions and the second convex portions is so formed as to have a larger width as being farther from the first end and the second end of the metal sheet, respectively.

6. The method as set forth in claim 5, wherein:
each of the first convex portions and the second convex portions is formed with a protrusion protruded in the first direction.

7. The method as set forth in claim 4, wherein:
the metal sheet is provided by rolling a metal block in the second direction.

8. A method of manufacturing a roller, comprising:
placing the pipe member manufactured by the method as set forth in claim 4 in a die; and
injecting a molten elastic material into the die to form an elastic layer on an outer periphery of the pipe member.
